(19) United States
(12) Patent Application Publication
(10) Pub. No.: US 2008/0192633 A1
(43) Pub. Date: Aug. 14, 2008

(54) APPARATUS AND METHOD FOR CONTROLLING DATA FLOW IN COMMUNICATION SYSTEM

(75) Inventor: Yong-Sang AHN, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/025,246

(22) Filed: Feb. 4, 2008

(30) Foreign Application Priority Data
Feb. 9, 2007 (KR) 2007-14008

(51) Int. Cl. G01R 31/08

(52) U.S. Cl. 370/231

(57) ABSTRACT

An apparatus and method for controlling data flow in a communication system are provided. In such an apparatus and method, a switch identifies a source address of a data frame received through each of a plurality of input ports, determines the size of the data frame received from the source address, creates a first pause frame to be transmitted to at least one source address selected based on consideration of the size of data frames received from respective source addresses for a period of time when the size of data frames stored in an output buffer of an output port exceeds a first threshold, and transmits the created first pause frame to the selected source address. The first pause frame is adapted to interrupt transmission of data frames of low importance. The apparatus and method are advantageous in that, by using a pause frame for selectively controlling the transmission/reception of data frames based on the importance of data in a communication system, the flow of data input/output through the switch of the communication system is better controlled and service interruptions are minimized.

### PRIORITY

This application claims the benefit under 35 U.S.C. §119(a) of a Korean patent application filed in the Korean Intellectual Property Office on Feb. 9, 2007 and assigned Serial No. 2007-0014008, the entire disclosure of which is hereby incorporated by reference.

### BACKGROUND OF THE INVENTION

1. Field of the Invention

The present invention relates to a communication system. More particularly, the present invention relates to data flow control in a communication system.

2. Description of the Related Art

As generally known in the art, a communication system is connected to a network, such as an Ethernet, and transmits/receives data via the network. For such transmission/reception of data, the communication system has, for example, a switch connected to the network. The switch outputs data, which has been received from the network, to communication devices inside the system, such as a Base Station Controller (BSC), a Base Station (BS), or a Mobile Station (MS).

In the case of such a switch for transmitting data from the network to respective communication devices inside the communication system, the flow of data received from the network access terminal must be controlled.

Examples of data flow control in networks adopting a half-duplex mode include forced collision, forced carrier sensing, and aggressive back-off. Examples of data flow control in networks adopting a full-duplex mode include the use of a pause frame.

To be more specific, the pause frame, which is used to control the data flow in a network that adopts a full-duplex scheme, is a control frame for interrupting the transmission of data frames other than Medium Access Control (MAC) frames, which belong to the MAC layer. The structure of a conventional switch for controlling the data flow by using the pause frame will now be described with reference to FIG. 1.

FIG. 1 shows a switch for controlling the data flow in a conventional communication system.

Referring to FIG. 1, the communication system includes a switch 110, which has at least one input port and at least one output port. It will be assumed for convenience of description that there are three input ports a, b, and c, and there is one output port d.

When connected to a BSC, for example, the switch 110 is positioned between the BSC and the network and may be located inside the BSC. In this case, the input ports of the switch 110 are connected to the network and the output port is connected to the BSC. The input buffers of respective input ports a, b, and c temporarily store data input to their respective input ports and output the data to the output buffer of the output port d.

As illustrated in FIG. 1, when the size of data frames stored in the output buffer exceeds a predetermined pause frame creation threshold, the switch 110 selects a specific port to which a pause frame is to be transmitted. The pause frame is used to interrupt the transmission of data frames, as mentioned above. Based on the port selection, a pause frame is created to interrupt the transmission of data frames through the selected port and the created pause frame is transmitted to the corresponding input port, data transmission through which is to be interrupted. When a specific communication system or every communication system has received the pause frame, the transmission of data frames other than MAC frames is interrupted. The structure of the pause frame will now be described with reference to FIG. 2.

FIG. 2 shows a pause frame for controlling the data flow in a conventional communication system.

Referring to FIG. 2, a MAC control frame is shown, which includes a Destination Address (DA) as a multicast address, a Source Address (SA), an Etype (length/type) indicating the length and type of frames, an opcode indicating the type of the MAC frame, an operand acting as a MAC control parameter area, a PAD, and a Frame Check Sequence (FCS) for error detection.

The opcode has a size of 2 bytes, for example, and indicates the type of the MAC frame. The currently defined opcode is 0x0001, which indicates that the current frame is a pause frame. That is, the pause frame corresponds to a “00-01” setting of the opcode, while the other values of the opcode are reserved. The pause frame is transmitted to interrupt the transmission of data frames during the time section corresponding to the operand. The operand has a value depending on the opcode. That is, the operand includes the time to pause in the case where the opcode indicates a pause frame. The operand occupies 20 bytes of the minimum frame size. For example, a 100 bps system has a minimum frame size of 64 bytes, which corresponds to the total length leading from the DA to the frame control sequence, and the parameter area (i.e. operand area) has a maximum length of 44 bytes (=64−20). If there is no operand area, a PAD of a total of 44 bytes is attached to satisfy the minimum frame size condition.

As mentioned above, the use of a pause frame to interrupt the transmission of data frames for a period of time has a problem in that, because the process of receiving data frames through the corresponding port is interrupted, communication with the system using the corresponding source address is also interrupted. In other words, when a pause frame is used, even a system or an MS that does not generate a substantial amount of traffic may fail to normally transmit/receive data. Furthermore, the service quality necessary to provide a real-time data service may not be guaranteed, even in the case of a data service of high importance, such as a Video on Demand (VOD), Internet telephoning, video conferencing and the like.

### SUMMARY OF THE INVENTION

An aspect of the present invention is to address the above-mentioned problems and/or disadvantages and to provide at least the advantages described below. Accordingly, an aspect of the present invention to provide an apparatus and a method for controlling the flow of data in a communication system.

Another aspect of the present invention is to provide an apparatus and a method for controlling the flow of data input/output through a switch in a communication system.

Furthermore, another aspect of the present invention is to provide an apparatus and a method for controlling the flow of data so that a data service is provided without interruption while it is transmitted/received in a communication system.

Still a further aspect of the present invention is to provide an apparatus and a method for controlling the flow of data so that a data service is provided according to the importance of data in a communication system.

In accordance with an aspect of the present invention, a method for controlling a data flow by a switch in a communication system is provided. The method includes identifying a source address of a data frame received through at least one input port and measuring a size of the data frame received from the source address, creating a first pause frame to be transmitted to at least one source address selected based on consideration of a size of data frames received from respective source addresses for a period of time when a size of data frames stored in an output buffer of an output port exceeds a first threshold and transmitting the created first pause frame to the selected source address, wherein the first pause frame is adapted to interrupt transmission of data frames of low importance.

In accordance with another aspect of the present invention, an apparatus for controlling a data flow in a communication system is provided. The apparatus includes a switch for identify a source address of a data frame received through at least one input port, for measuring a size of the data frame received from the source address, for creating a first pause frame to be transmitted to at least one source address selected based on consideration of a size of data frames received from respective source addresses for a period of time when a size of data frames stored in an output buffer of an output port exceeds a first threshold, and for transmitting the created first pause frame to the selected source address, wherein the first pause frame is adapted to interrupt transmission of data frames of low importance.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 shows a switch for controlling the flow of data in a conventional communication system;

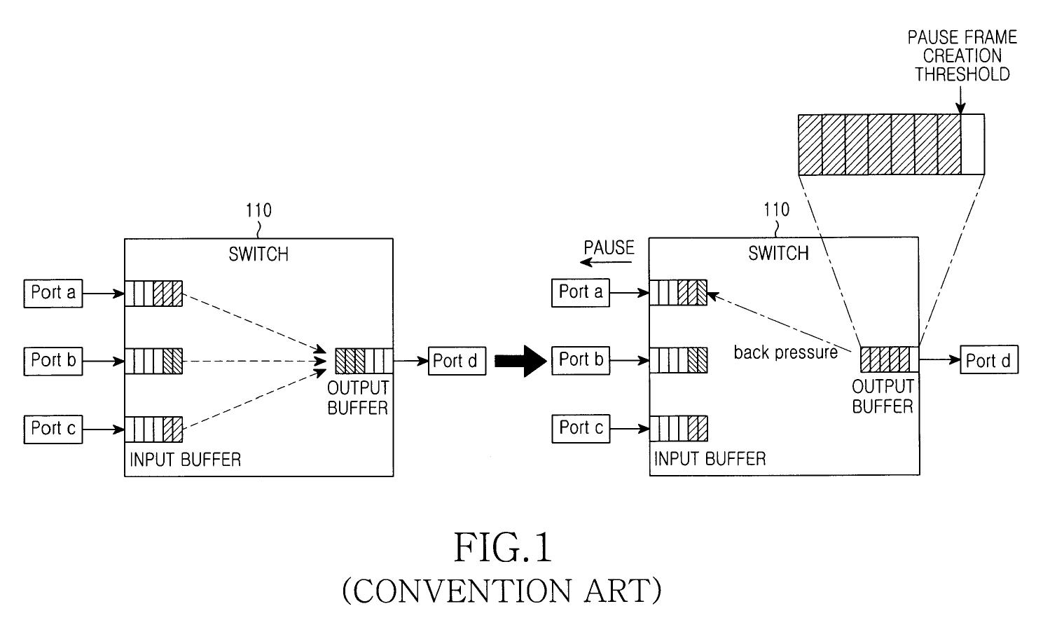

FIG. 2 shows a pause frame for controlling the flow of data in a conventional communication system;

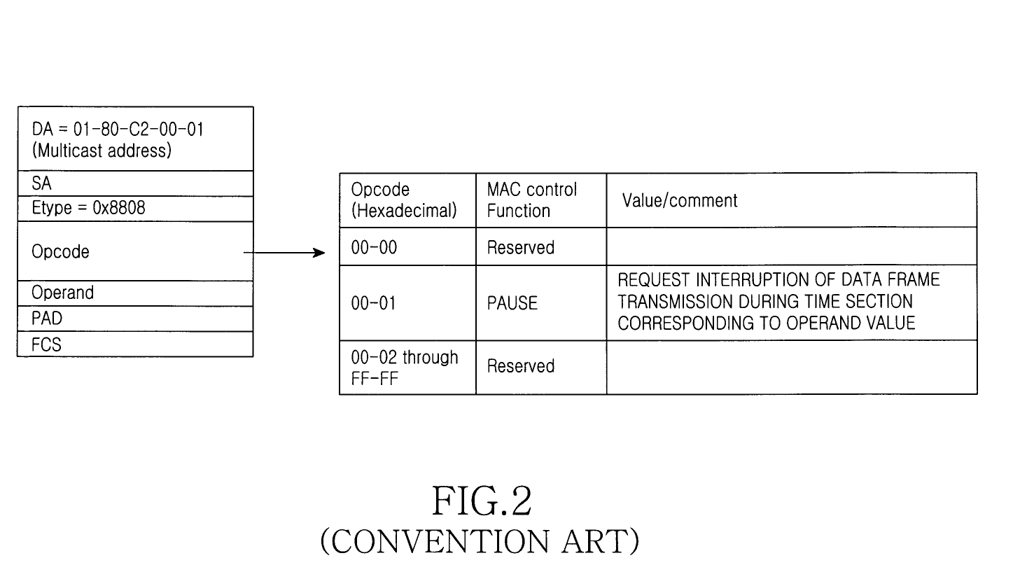

FIG. 3 shows a switch for controlling the flow of data according to an exemplary embodiment of the present invention;

FIG. 4 shows the construction of a pause frame for controlling the flow of data according to an exemplary embodiment of the present invention;

FIG. 5 shows the structure of a switch according to an exemplary embodiment of the present invention; and

FIG. 6 shows the operation of a switch according to an exemplary embodiment of the present invention.

Throughout the drawings, it should be noted that like reference numbers are used to depict the same or similar elements, features and structures.

### DETAILED DESCRIPTION OF THE EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and a method for controlling the data flow in a communication system. To this end, an exemplary communication system employs a sub-pause frame to selectively control the transmission/reception of data frames according to the importance of data, in addition to the conventional pause frame. According to exemplary embodiments of the present invention, the Source Address (SA) of data frames received through respective input ports of a switch connected to a network is identified, and the size of data frames received based on the SA for a period of time is measured. If the size of data frames stored in the output buffer of the output port exceeds a threshold, a sub-pause frame is created to be transmitted to at least one SA selected according to the size of data frames received based on respective SAs, and the created sub-pause frame is transmitted to the selected SA to control the data flow. The sub-pause frame is used to interrupt the transmission of data frames of little importance.

Exemplary embodiments of the present invention employ a switch connected to a network, such as an Ethernet, to control the flow of data. The switch may be connected to the network and to a communication device of the communication system. The communication device may include a Base Station Controller (BSC), a Base Station (BS), a Mobile Station (MS) and the like. It will be assumed, for convenience of description of the present invention and merely as an example, that the input port of the switch is connected to the network and that the output ports of the switch are connected to the BSC. Therefore, the switch may be positioned between the network and the BSC external to the BSC or inside the BSC, but the location of the switch is for the convenience of description only, and is not limited thereto.

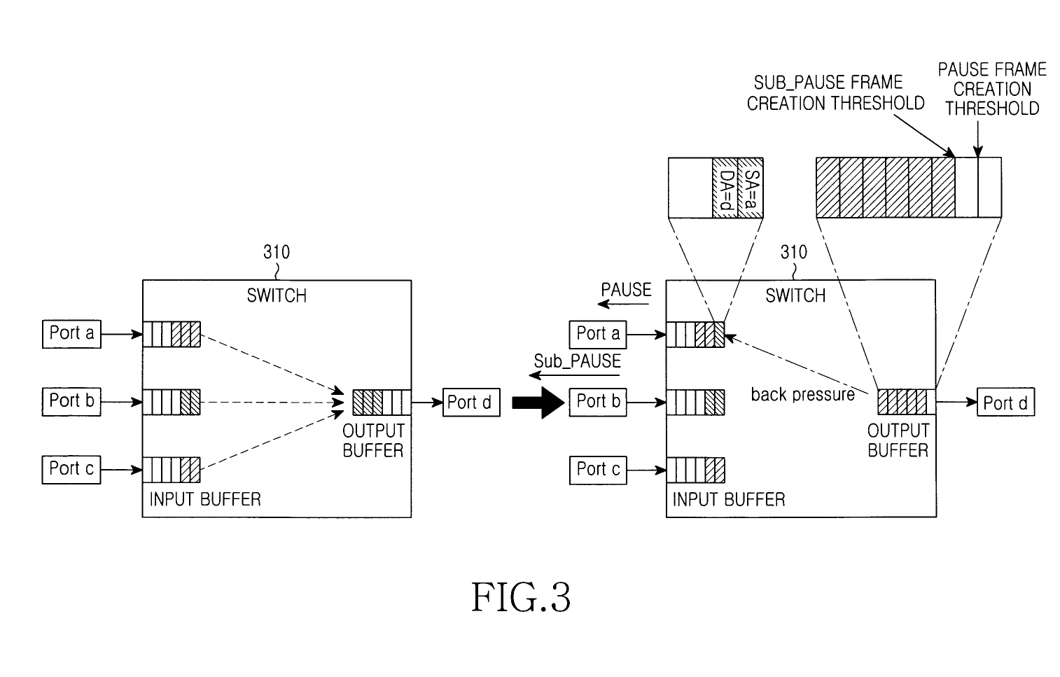

The operation of a switch according to an exemplary embodiment of the present invention will now be described with reference to FIG. 3.

FIG. 3 shows a switch for controlling data flow according to an exemplary embodiment of the present invention.

Referring to FIG. 3, a communication system includes a switch 310, which has at least one input port and at least one output port. It will be assumed for convenience and ease of description only that there are three input ports a, b, and c, and there is one output port d. Of course, this number of input and output ports is merely exemplary. The input buffers of respective input ports a, b, and c temporarily store data input through their respective input ports and output the data to the output buffer of the output port d.

When data frames are received through a number of input ports and then output through a single output port in this manner, a number of data frames exceeding the capacity of the output buffer may flow into the output port. The conventional approach to solve this problem is to transmit a frame (pause frame) to a specific input port generating many data frames by using multicast, for example. However, such an approach creates a problem in that the transmission of data frames from all input ports is limited, even with regard to a system or an MS generating fewer data frames.

In contrast, according to an exemplary embodiment of the present invention, a sub-pause frame is created based on a Source Address (SA) generating a large number of data frames. The SA refers to the Medium Access Control (MAC) address, which belongs to the MAC layer. In addition, exemplary embodiments of the present invention subdivide the threshold based on the size of data contained in the output buffer in order to transmit the sub-pause frame.

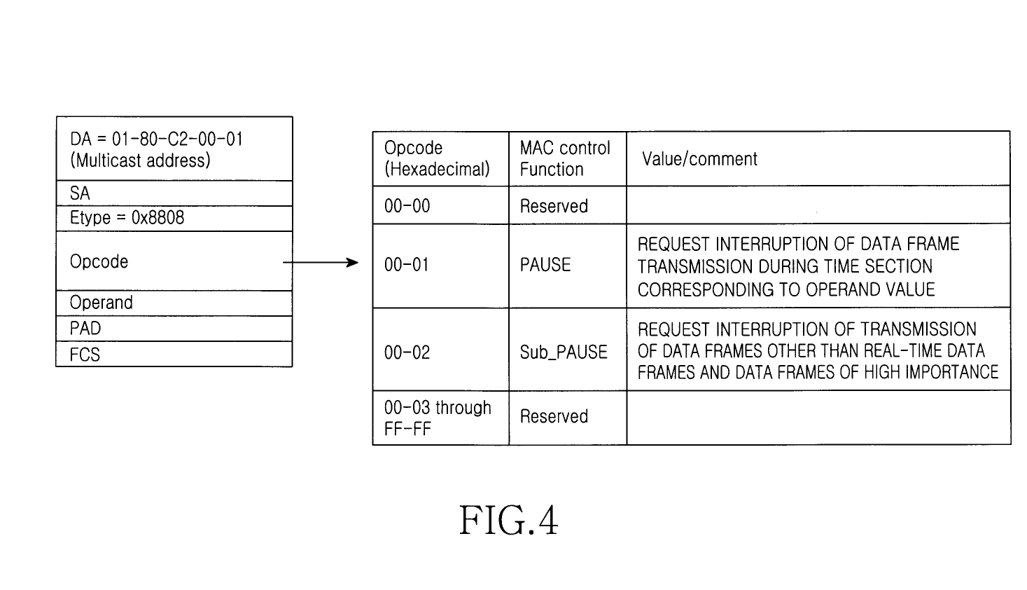

When the size of data frames stored in the output buffer exceeds a pause frame creation threshold, the switch 310 selects a specific port to which a pause frame is to be transmitted. The pause frame is used to interrupt the transmission of data frames, as mentioned above. Then, a pause frame is created to interrupt the transmission of data frames through the selected port and the created pause frame is transmitted to the specific port, data transmission through which is to be interrupted. According to an exemplary embodiment of the present invention, however, the pause frame creation threshold of the input or output buffer is subdivided, as will be discussed with reference to FIG. 4 below, so that the created pause frame can be used to control the flow for each service, each port and the entire system based on the stage. This guarantees a predetermined level of service reliability and quality.

That is, according to exemplary embodiments of the present invention, the switch 310 creates a sub-pause frame when the size of data frames stored in the output buffer exceeds a sub-pause frame creation threshold. The sub-pause frame is used to control the transmission of data frames in such a manner that data frames are limitedly transmitted according to the importance of data. Particularly, the sub-pause frame is used to interrupt the transmission of data of low importance and to allow the transmission of data of high importance, such as real-time data (e.g. VOD, Internet telephoning, video conferencing).

The switch 310 also measures the size of data frames transmitted from respective SAs for a period of time. If the measured size exceeds the sub-pause frame creation threshold, the switch 310 transmits the sub-pause frame to at least one SA starting from an SA having the largest data frame size.

The structure of an exemplary pause frame will now be described with reference to FIG. 4.

FIG. 4 shows the construction of a pause frame for controlling the flow of data according to an exemplary embodiment of the present invention.

Referring to FIG. 4, a MAC control frame is shown, which includes a Destination Address (DA) as a multicast address, an SA, an Etype (length/type) indicating the length and type of frames, an opcode indicating the type of the MAC frame, an operand acting as a MAC control parameter area, a PAD, and a Frame Check Sequence (FCS) for error detection.

The opcode has a size of 2 bytes, for example, and indicates a type of the MAC frame. The pause frame corresponds to a “00-01” setting of the opcode, while the other values of the opcode are reserved. In this case, the opcode indicates that the current frame is a pause frame.

The sub-pause frame corresponds to a “00-02” setting of the opcode and is used to request the interruption of transmission of data frames other than those of high importance, such as real-time data, data having a required service quality level higher than a threshold, etc., as mentioned above. As in the case of the pause frame, the sub-pause frame interrupts the transmission of data frames of low importance during a time section corresponding to the value of the operand. In this case, according to an exemplary embodiment of the present invention, the opcode indicates that the current frame is a sub-pause frame.

Furthermore, in the case of the sub-pause frame according to an exemplary embodiment of the present invention, at least one opcode can be set by using the reserved values of the MAC control frame between 00-02 and FF-FF.

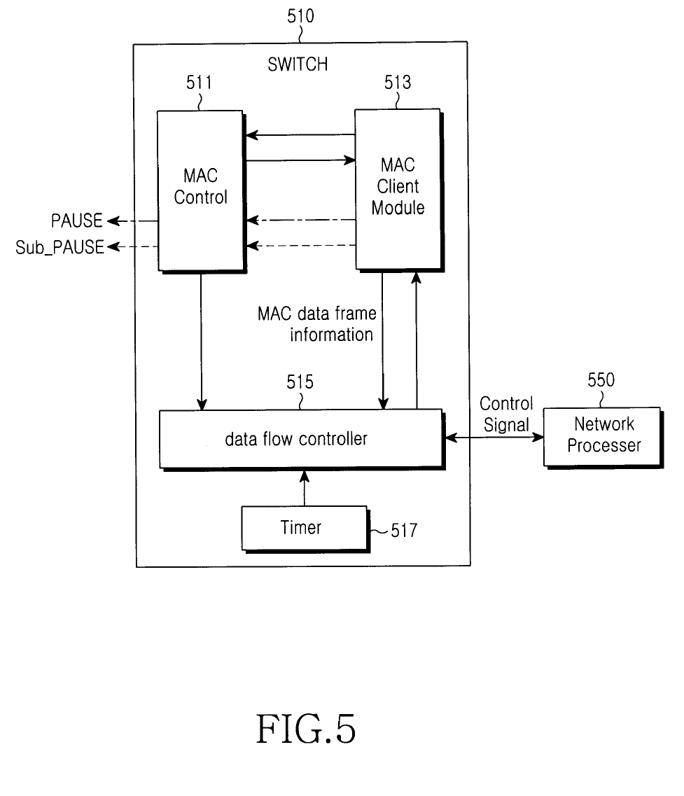

The pause frame is transmitted to interrupt the transmission of data frames during the time section corresponding to the operand. The operand has a value depending on the opcode. That is, the operand includes the time to pause in the case where the opcode indicates a pause frame. The operand occupies 20 bytes of the minimum frame size. For example, a 100 Mbps system has a minimum frame size of 64 bytes, which corresponds to the total length leading from the DA to the frame control sequence, and the parameter area (i.e. operand area) has a maximum length of 44 bytes (=64−20). If there is no operand area, a PAD of a total of 44 bytes is attached to satisfy the minimum frame size condition. The structure of the switch will now be described with reference to FIG. 5.

FIG. 5 shows the structure of a switch according to an exemplary embodiment of the present invention.

Referring to FIG. 5, the switch 510 includes a MAC controller 511, a MAC client module 513, a data flow controller 515 and a timer 517. A network processor 550 corresponding to the switch 510 transmits/receives a control signal to/from the switch so that information of the data flow controller 515 is transmitted to the network processor 550, or signals necessary for control operations are transmitted/received.

The data flow controller 515 receives the MAC data frame information from the MAC client module 513. The MAC data frame information includes information regarding the source addresses and the size of data frames received from respective source addresses. The data flow controller 515 identifies the source addresses contained in MAC control frames obtained by the MAC controller 511 during a time section and measures the size of data frames received by the MAC client module 513.

The data flow controller 515 selects a source address generating data frames in a large quantity or with a high frequency based on the MAC data frame information. The data frames may be sorted in the order of their quantity or frequency to select a source address. In an exemplary implementation, at least one source address can be selected.

The data flow controller 515 determines if the data stored in the output buffer of the switch has exceeded a sub-pause frame creation threshold. Regarding the sub-pause frame creation threshold, as explained above with reference to FIG. 4, the pause frame creation threshold of the input or output buffer is subdivided so that the created pause frame can be used to control the flow for each service, each port and the entire system based on the stage. This guarantees a predetermined level of service reliability and quality.

If it is confirmed that the data stored in the output buffer of the switch has exceeded the sub-pause frame creation threshold, the data flow controller 515 controls the MAC client module 513 so as to create the sub-pause frame.

In addition, the data flow controller 515 receives a MAC control frame from the MAC controller 511.

After creating the sub-pause frame, the MAC client module 513 outputs the created sub-pause frame to the MAC controller 511.

After receiving the sub-pause frame, the MAC controller 511 outputs the sub-pause frame to the corresponding source address.

By transmitting the sub-pause frame, it is possible to control the data flow in such a manner that, according to the importance of data, data frames of high importance can be solely transmitted.

In order to transmit the pause frame in addition to the sub-pause frame, the data flow controller 515 determines if the size of data stored in the output buffer exceeds the pause frame creation threshold. If the size of data stored in the output buffer exceeds the pause frame creation threshold, the data flow controller 515 controls the MAC client module 513 so as to create a pause frame.

The MAC client module 513 outputs the created pause frame to the MAC controller 511.

The MAC controller 511 transmits the created pause frame to the corresponding input port or to the corresponding source address so that data frames other than MAC control frames are not received.

Although it has been assumed in the above description that only one sub-pause frame is created, at least two sub-pause frames may be used according to the size of data frames stored in the output buffer. To this end, at least two sub-pause frame creation thresholds are used according to the size of data stored in the output buffer. In such an exemplary implementation, the data frames may be divided into a number of groups according to the importance and the transmission of data frames may be limited based on respective sub-pause frames.

For example, it will be assumed that two sub-pause frames are created. Then, the data frames are divided into a first group of data frames of the highest importance, a second group of data frames of the next highest importance and a third group of data frames of the lowest importance. When the first sub-pause frame is transmitted, control is conducted so that data frames of the first group can be solely transmitted. When the second sub-pause frame is transmitted, control is conducted so that data frames of the first and second groups can be solely transmitted. When the pause frame is transmitted, the transmission of data frames of all groups is interrupted. In an exemplary implementation, the importance of data frames may be determined as follows. When a service is provided through the data frames, data frames requiring a high service quality level may be given high importance. Alternatively, considering the characteristics of the real-time data frames, data frames that must be transmitted in real time may be given high importance.

The data flow controller 515 determines how many times data frames have been transmitted, as well as their size for each MAC address (i.e. source address) based on the MAC control frame received from the MAC controller 511 and the MAC data frame information received from the MAC client module 513 The data flow controller 515 stores the determined information.

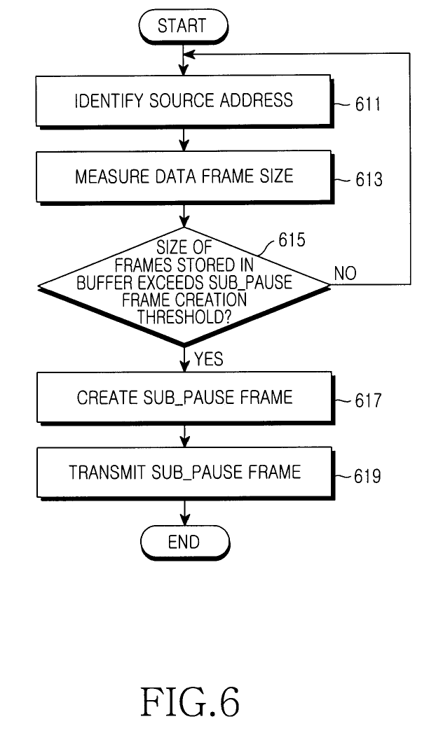

At a data transmission/reception request of the upper layer of the switch, the MAC control layer of the data flow controller 515 may either delay or discard the request according to its own operating condition. Such information may be obtained by receiving the MAC control frame from the MAC controller. The timer 517 performs timing so that the information stored in the data flow controller 515 is deleted when a time section has passed. The operation process of the switch will now be described with reference to FIG. 6.

FIG. 6 shows the operation of a switch according to an exemplary embodiment of the present invention.

Referring to FIG. 6, the switch identifies the MAC address (i.e. source address) used to transmit a data frame in step 611.

In step 613, the switch measures the size of the data frame corresponding to the source address. Alternatively, the switch may measure the frequency of creation of the data frame. In addition, there may be a number of source addresses and the size of received data frames is measured with regard to respective source addresses.

In step 615, the switch determines if the size of frames stored in the buffer exceeds a sub-pause frame creation threshold.

If it is determined that the size of frames stored in the buffer is below the sub-pause frame creation threshold, the switch returns to step 611.

If it is determined that the size of frames stored in the buffer exceeds the sub-pause frame creation threshold, the switch proceeds to step 617.

In step 617, the switch creates a sub-pause frame.

In step 619, the switch transmits the sub-pause frame to the corresponding source address. The switch transmits the sub-pause frame to a source address generating data frames in a large quantity or with a high frequency. Therefore, when the sub-pause frame is received, the transmission of data frames is interrupted except for data of high importance.

Although not described in detail with reference to FIG. 6, if the pause frame creation threshold, not the sub-pause frame creation threshold, is exceeded, a pause frame is created and is transmitted to the corresponding input port or source address to control the transmission of data frames. According to exemplary embodiments of the present invention, the sub-pause frame creation threshold is smaller than the pause frame creation threshold.

In summary, exemplary embodiments of the present invention propose that a switch is used to control the transmission/reception of data frames and that data flow is controlled based on subdivision of data importance. As a result, a communication system has fewer service interruptions.

As mentioned above, exemplary embodiments of the present invention are advantageous in that, by using a sub-pause frame for selectively controlling the transmission/reception of data frames based on the importance of data in a communication system, the flow of data input/output through the switch of the communication system is controlled accordingly. In addition, a data service can be provided without interrupting the transmission/reception of the data service in the communication system. The data service can also be provided according to the importance of data. The resulting control of data flow in the communication system connected to a network guarantees the reliability of the entire system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling a data flow by a switch in a communication system, the method comprising:
identifying a source address of a data frame received through at least one input port and measuring a size of the data frame received from the source address;
creating a first pause frame to be transmitted to at least one source address selected based on consideration of a size of data frames received from respective source addresses for a period of time when a size of data frames stored in an output buffer of an output port exceeds a first threshold; and
transmitting the first pause frame to the selected source address,
wherein the first pause frame is adapted to interrupt transmission of data frames of low importance.

2. The method as claimed in claim 1, further comprising transmitting a second pause frame to at least one of the selected source address and the at least one input port, when the size of data frames stored in the output buffer of the output port exceeds a second threshold, so that transmission of data frames other than Medium Access Control (MAC) frames is interrupted.

3. The method as claimed in claim 2, wherein the second threshold is larger than the first threshold.

4. The method as claimed in claim 1, wherein the source address comprises a Medium Access Control (MAC) address.

5. The method as claimed in claim 1, wherein, when the data frame comprises real-time data, the data frame is classified as high importance.

6. The method as claimed in claim 1, wherein, when the data frame comprises a required service quality level that exceeds a threshold, the data frame is classified as high importance.

7. An apparatus for controlling a data flow in a communication system, the apparatus comprising:
a switch for identifying a source address of a data frame received through at least one input port, for measuring a size of the data frame received from the source address, for creating a first pause frame to be transmitted to at least one source address selected based on consideration of a size of data frames received from respective source addresses for a period of time when a size of data frames stored in an output buffer of an output port exceeds a first threshold and for transmitting the created first pause frame to the selected source address, wherein the first pause frame is adapted to interrupt transmission of data frames of low importance.

8. The apparatus as claimed in claim 7, wherein the switch is adapted to transmit a second pause frame to at least one of the selected source address and the at least one input port, when the size of data frames stored in the output buffer of the output port exceeds a second threshold, so that transmission of data frames other than Medium Access Control (MAC) frames is interrupted.

9. The apparatus as claimed in claim 7, wherein the second threshold is larger than the first threshold.

10. The apparatus as claimed in claim 7, wherein the source address comprises a Medium Access Control (MAC) address.

11. The apparatus as claimed in claim 7, wherein, when the data frame comprises real-time data, the data frame is classified as high importance.

12. The apparatus as claimed in claim 7, wherein, when the data frame comprises a required service quality level exceeds a threshold, the data frame is classified as high importance.

13. The apparatus as claimed in claim 7, wherein the switch comprises:
an input buffer for storing data frames input from a network;
an output buffer for storing output data frames;
a Medium Access Control (MAC) client module for creating data frame information and a first pause frame;
a data flow controller for receiving the data frame information and controlling the MAC client module so as to create the first pause frame when a size of data frames stored in the output buffer exceeds the first threshold; and
a MAC controller for transmitting the first pause frame created by the MAC client module to a corresponding source address.

14. The apparatus as claimed in claim 13, wherein the data frame information comprises source addresses and a size of data fames received from the source addresses.

15. The apparatus as claimed in claim 13, wherein the MAC controller is adapted to transmit a MAC control message to the data flow controller.

16. The apparatus as claimed in claim 13, wherein the first pause frame is transmitted to at least one source address generating data frames with a higher frequency and in a larger quantity.

17. A method for controlling a data flow by a switch in a communication system, the method comprising:
identifying a source address of a data frame received through an input port;
measuring a size of the data frame received from the source address;
creating a first pause frame when a size of data frames exceeds a first threshold; and
transmitting the first pause frame to the source address,
wherein the first pause frame is adapted to interrupt transmission of data frames of low importance.

18. The method as claimed in claim 17, further comprising transmitting a second pause frame to the source address when the size of data frames exceeds a second threshold, so that transmission of data frames other than Medium Access Control (MAC) frames is interrupted.

19. The method as claimed in claim 18, wherein the second threshold is larger than the first threshold.

20. The method as claimed in claim 17, wherein, when the data frame comprises at least one of real-time data and a required service quality level that exceeds a threshold, the data frame is classified as high importance.
